(19) United States
(12) Patent Application Publication
(10) Pub. No.: US 2021/0285111 A1
(43) Pub. Date: Sep. 16, 2021

(54) Method and Device for the Electrochemical Utilization of Carbon Dioxide

(71) Applicant: Siemens Aktiengesellschaft, München (DE)

(72) Inventors: Elvira María Fernández Sanchis, Erlangen (DE); Marc Hanebuth, Nürnberg (DE); Ralf Krause, Herzogenaurach (DE); Katharina Meltzer, Erlangen (DE)

(73) Assignee: Siemens Aktiengesellschaft, München (DE)

(21) Appl. No.: 16/336,758

(22) PCT Filed: Aug. 24, 2017
(86) PCT No.: PCT/EP2017/071294

§ 371 Date: Mar. 26, 2019

(30) Foreign Application Priority Data
Sep. 27, 2016 (DE) 10 2016 218 517.9
Oct. 18, 2016 (DE) 10 2016 220 297.9

(51) Int. Cl. C25B 1/00; C25B 9/21; B01D 61/54; B01D 61/52; B01D 61/42; C25B 15/08

(52) U.S. Cl. CPC C25B 1/00; C25B 9/21; B01D 61/54; B01D 2257/504; B01D 61/422; C25B 15/085; B01D 61/52

(57) ABSTRACT

Various embodiments include a method for electrochemical utilization of carbon dioxide comprising: reducing carbon dioxide to a product gas in an electrolysis cell of an electrolyzer; delivering the product gas comprising carbon dioxide into a gas scrubbing apparatus; scrubbing the product gas to remove carbon dioxide using an absorbent in the gas scrubbing apparatus; regenerating the absorbent in an electrodialysis cell of an electrodialysis unit; at least partly recycling the regenerated absorbent into the gas scrubbing apparatus; and at least partly recycling the carbon dioxide released during the regenerating as reactant gas into the electrolyzer.

### CROSS-REFERENCE TO RELATED APPLICATIONS

This application is a U.S. National Stage Application of International Application No. PCT/EP2017/071294 filed Aug. 24, 2017, which designates the United States of America, and claims priority to DE Application No. 10 2016 220 297.9 filed on Oct. 18, 2016 and DE Application No. 10 2016 218 517.9 filed Sep. 27, 2016, the contents of which are hereby incorporated by reference in their entirety.

### TECHNICAL FIELD

The present disclosure relates to electrochemistry. Various embodiments may include processes and apparati for electrochemical utilization of carbon dioxide, e.g., an electrolyzer, a gas scrubbing apparatus, and an electrodialysis unit.

### BACKGROUND

The demand for power varies significantly over the course of the day. There is also variation in the generation of power, with an increasing proportion of power from renewable energies during the course of the day. In order to be able to compensate for an oversupply of power in periods with a lot of sun and strong wind when demand for power is low, controllable power plants or storage means are used to store this energy. One of the solutions currently being contemplated is the conversion of electrical energy to products of value, especially platform chemicals or synthesis gas. These products of value are particularly advantageously prepared from carbon dioxide inter alia. This leads to a reduction in CO₂ emissions. Typical products of value are especially substances such as carbon monoxide and ethylene. One possible technique for conversion of electrical energy with simultaneous preparation of products of value from carbon dioxide is electrolysis.

An electrolyzer that produces materials of value from carbon dioxide is typically operated with a liquid electrolyte. This liquid electrolyte is guided through an anode space and/or cathode space. For thermodynamic and kinetic reasons, a portion of the carbon dioxide reactant is transferred into the liquid electrolyte. Typically, hydroxide ions form in the liquid electrolyte during the reduction of carbon dioxide at the cathode, and these are converted with the carbon dioxide present from the gas phase to hydrogencarbonate. Carbon dioxide is then removed from the gas phase. Since the liquid electrolyte should be circulated for economic and environmental reasons, the electrolyte is enriched with carbon dioxide in each cycle in this way until a steady state is established. In this steady state, the system tends to release the carbon dioxide again to another point in the process. More particularly, the release will usually be via the anode gas to the environment. Alternatively, the carbon dioxide can pass into the product gas. This leads to lower yields and a loss of carbon dioxide, and to dilution of the product, especially carbon monoxide, with carbon dioxide.

### SUMMARY

The teachings of the present disclosure describe processes and apparati which may reduce the carbon dioxide content of a product gas from a carbon dioxide electrolyzer. For example, some embodiments include a process for electrochemical utilization of carbon dioxide, comprising the following steps: reducing carbon dioxide to a product gas (PGCO2) in an electrolysis cell (EZ) of an electrolyzer (EL), guiding the product gas (PGCO2) comprising carbon dioxide into a gas scrubbing apparatus (GW), scrubbing the product gas (PGCO2) to remove carbon dioxide by means of an absorbent (Ab) in the gas scrubbing apparatus (GW), regenerating the absorbent (AbCO2) in an electrodialysis cell of an electrodialysis unit (ED), at least partly recycling the regenerated absorbent (Ab) into the gas scrubbing apparatus (GW), and at least partly recycling the carbon dioxide released during the regenerating as reactant gas (EG) into the electrolyzer (EL).

In some embodiments, carbon dioxide accumulates in a salt-containing liquid electrolyte (Ely) used in the electrolysis cell (EZ) and the carbon dioxide-enriched salt-containing liquid electrolyte (ElyCO2) is guided into the electrodialysis cell and the carbon dioxide content in the salt-containing liquid electrolyte is reduced by means of electrodialysis in the electrodialysis cell (EZ).

In some embodiments, the absorbent (Ab) used in the gas scrubbing apparatus (GW) is the salt-containing liquid electrolyte (Ely) with the reduced carbon dioxide content.

In some embodiments, the electrodialysis cell (ED) comprises an anode (303) and a cathode (304) and a multitude of bipolar membranes (302) and a multitude of cation-selective membranes (301) are in an alternating arrangement between anode (303) and cathode (304) and the membranes form first chambers (K1) and second chambers (K2), where the first chambers (K1) are bounded toward the anode (303) by the bipolar membrane (302) and the second chambers (K2) are bounded toward the anode (303) by the cation-selective membrane (301), and the salt-containing electrolyte (Ely) and/or the absorbent (Ab) is guided into the first chambers (K1).

In some embodiments, the salt-containing electrolyte (Ely) is guided first into the first chambers (K1) of the electrodialysis cell, and then into the second chambers (K2) of the electrodialysis cell.

In some embodiments, the electrodialysis cell comprises an anode (303) and a cathode (304) and a multitude of bipolar membranes (302) and a multitude of anion-selective membranes (301) are in an alternating arrangement between anode (303) and cathode (304) and the membranes form first chambers (K1) and second chambers (K2), where the first chambers (K1) are bounded toward the anode (303) by the bipolar membrane (302) and the second chambers (K2) are bounded toward the anode (303) by the anion-selective membrane, and the salt-containing electrolyte (Ely) and/or the absorbent (Ab) is guided into the second chambers (K2).

In some embodiments, a salt used in the salt-containing electrolyte (Ely) is a potassium salt, especially a potassium hydrogen carbonate (KHCO3) and/or a potassium sulfate.

In some embodiments, the electrolyzer (EL) is operated with a small carbon dioxide excess.

In some embodiments, the electrodialysis unit (ED) is operated at a higher operating pressure than the electrolyzer (EL).

In some embodiments, the product gas (PG) comprises carbon monoxide and/or ethene.

As another example, some embodiments include an apparatus for performing the process for electrochemical utilization of carbon dioxide as described herein, comprising: an electrolyzer (EL) having at least one electrolysis cell (EZ) for reduction of carbon dioxide to a product gas (PGCO2), a gas scrubbing apparatus (GW) configured to absorb unconverted carbon dioxide from the product gas (PGCO2) at least partly into an absorbent (Ab), and an electrodialysis unit (ED) having at least one electrodialysis cell suitable for regenerating the absorbent (AbCO2) enriched with carbon dioxide during the absorption.

In some embodiments, the electrodialysis cell comprises a multitude of bipolar membranes (302) and a multitude of cation-selective membranes (301) or anion-selective membranes and these are in an alternating arrangement between an anode (303) and a cathode (304).

In some embodiments, the electrodialysis unit (ED) is integrated into the electrolyzer (EL).

In some embodiments, the electrodialysis unit (ED) and the electrolyzer (EL) comprise a common voltage source.

In some embodiments, the number of electrolysis cells (EZ) is greater than the number of electrodialysis cells.

### BRIEF DESCRIPTION OF THE DRAWINGS

Further configurations and further features of the teachings herein are elucidated in detail with reference to the figures which follow. The figures show:

FIG. 1 a phase diagram of potassium ions and carbon dioxide;

FIG. 2 an apparatus incorporating the teachings herein with a gas scrubbing apparatus, an electrolyzer, and an electrodialysis unit;

FIG. 3 a detail view of the electrodialysis unit with a phase separator; and

FIG. 4 an integrated electrodialysis and electrolyzer unit incorporating teachings of the present disclosure.

### DETAILED DESCRIPTION

In some embodiments, carbon dioxide is reduced to a product gas in an electrolysis cell of an electrolyzer. The product gas comprising unconverted carbon dioxide is guided into a gas scrubbing apparatus. The product gas is scrubbed to remove the carbon dioxide in the gas scrubbing apparatus by means of an absorbent. The absorbent is regenerated in an electrodialysis cell of an electrodialysis unit and then at least partly recycled into the gas scrubbing apparatus. The carbon dioxide released is at least partly recycled into the electrolyzer as reactant gas.

In some embodiments, an apparatus for electrochemical utilization of carbon dioxide comprises an electrolyzer having at least one electrolysis cell for reduction of carbon dioxide to a product gas. The apparatus further comprises a gas scrubbing apparatus configured to at least partly absorb unconverted carbon dioxide from the product gas into an absorbent. The apparatus further comprises an electrodialysis unit having at least one electrodialysis cell suitable for regenerating the absorbent enriched with carbon dioxide during the absorption. The absorbent is then appropriately at least partly guided via appropriate pipelines back into the gas scrubbing apparatus. The carbon dioxide released is at least partly recycled as reactant gas into the electrolyzer.

In an electrodialysis unit, anions and cations are transported to the respective electrodes by means of an external electrical field. The anions migrate here to the anode and the cations to the cathode. During the migration, the anions and cations are guided through cation- and anion-selective membranes. The cation- and anion-selective membranes are in an alternating arrangement. The anions can pass through the positively charged anion-selective membrane, but they are stopped at the next negatively charged cation-selective membrane. The same happens, with the reverse sign, with the cations as well. The effect of the electrodialysis is therefore an enrichment of the ions in every second chamber. In the chamber in between, there is depletion of the ions.

The processes described herein may enable the scrubbing of the product gas to free it of carbon dioxide in a gas scrubbing unit, with removal of the carbon dioxide from the product gas. In the gas scrubbing unit, it is possible to remove already low concentrations of carbon dioxide from the gas. In some embodiments, the use of a gas scrubbing unit avoids loss of carbon dioxide from the system since the carbon dioxide is at least partly recycled into the electrolyzer. By contrast, the carbon dioxide leaves the system when the carbon dioxide is not removed from the product gas.

In some embodiments, the system concentrates the electrolyte, then precipitates carbonate or hydrogencarbonate, dries it, and then drives out the carbon dioxide thermally by combustion and recycle it. In some embodiments, electrodialysis enables more efficient recycling of the carbon dioxide both in relation to the apparatuses used and in relation to the energy to be expended. In some embodiments, the electrodialysis unit comprises multiple electrodialysis cells. In some embodiments, the electrolyzer comprises multiple electrolysis cells that are typically arranged in “stacks”.

In some embodiments, a salt-containing liquid electrolyte is used in the electrolysis cell. Carbon dioxide accumulates in the salt-containing liquid electrolyte during the electrolysis. This carbon dioxide-enriched salt-containing liquid electrolyte is likewise guided into the electrodialysis cell. In the electrodialysis cell, the carbon dioxide content is reduced by means of electrodialysis in the salt-containing liquid electrolyte by forming gaseous carbon dioxide.

In some embodiments, this enables circulation of the liquid electrolyte in the process. The carbon dioxide can be removed continuously from the carbon dioxide-enriched electrolyte downstream of the electrolyzer. It can then be recycled particular into the electrolyzer and used in turn therein as electrolyte. What this enables is economic operation of the electrolysis cell and hence of the overall electrolyzer since the liquid electrolyte can be circulated repeatedly.

In some embodiments, the absorbent used in the gas scrubbing apparatus is the salt-containing liquid electrolyte with the reduced carbon dioxide content. In some embodiments, the use of an additional absorbent is avoided, which increases the efficiency of the process and makes the process environmentally benign since the salt-containing liquid electrolyte can be circulated continuously.

In some embodiments, the electrodialysis cell comprises a multitude of bipolar membranes and a multitude of cation-selective membranes in an alternating arrangement between an anode and a cathode. Bipolar membranes comprise a cation-selective membrane and an anion-selective membrane and a catalytic interlayer disposed in between that accelerates the dissociation of water into protons and hydroxide ions. The membranes form first chambers and second chambers, where the first chamber is bounded toward the anode by the bipolar membrane and the second chamber is bounded toward the anode by the cation-selective membrane. The bipolar membrane thus enables splitting of water molecules into protons and hydroxide ions with an electrical field applied, with enrichment of the different ions on the two opposite sides of the bipolar membrane. The salt-containing liquid electrolyte is guided into the first chamber.

In some embodiments, in the first chamber, the carbon dioxide content of the salt-containing liquid electrolyte is reduced. The use of the bipolar membrane enables this irrespective of the pH of the absorbent, or of the salt-containing liquid electrolyte. On application of a potential, the salt cation of the salt-containing liquid electrolyte, e.g. potassium or sodium, migrates through the cation-selective membrane from the first chamber into the second chamber toward the cathode. As charge balance, hydrogen ions are then replenished from the bipolar membrane. This moves the thermodynamic equilibrium in the first chamber in such a way that the partial pressure of carbon dioxide rises. It is then possible to increase the partial pressure of the carbon dioxide above the ambient pressure, such that the carbon dioxide can be removed with a simple phase separator.

In some embodiments, the salt-containing liquid electrolyte is first guided into the first chambers of the electrodialysis unit and, after gaseous carbon dioxide has been removed in a phase separator, then guided into the second chambers of the electrodialysis unit. In some embodiments, the liquid electrolyte is depleted of carbon dioxide in the first chamber. This means that carbonates, hydrogencarbonates, but also cations, especially potassium or sodium, are removed from the liquid electrolyte. The recycling through the second chamber of the electrodialysis unit results in enrichment of the liquid electrolyte with these cations in turn, especially potassium or sodium. In some embodiments, salts used are potassium hydrogen-carbonate or potassium sulfate, such that potassium is enriched in the salt-containing liquid electrolyte within the second chambers. This salt-enriched, especially potassium-enriched, salt-containing liquid electrolyte can be returned to the electrolysis and has a constantly good conductive.

In some embodiments, anion-selective membranes are in an alternating arrangement with the bipolar membranes. The membranes form first chambers and second chambers, where the first chamber is bounded toward the anode by the bipolar membrane and the second chamber is bounded toward the anode by the anion-selective membrane, and the salt-containing electrolyte is guided into the second chambers. On application of a potential, hydrogencarbonate ions and/or carbonate ions present migrate through the anion-selective membrane from the second chamber into the first chamber in the direction of the anode. Hydrogen ions are then replenished into the first chamber from the bipolar membrane, forming carbon dioxide and water from the hydrogencarbonate ion and the hydrogen. The carbon dioxide can then be removed in turn by means of a phase separator.

In some embodiments, the electrolyzer is operated with a small excess of carbon dioxide. In some embodiments, barely any hydrogen then forms in the cathode space. Hydrogen in this case is an unwanted component of the product gas. The desired product gas especially comprises carbon monoxide. In some embodiments, it is also possible to prepare ethylene in the electrolysis cell.

In some embodiments, the electrodialysis unit is operated at a higher operating pressure than the electrolyzer. This has the advantage that no additional fan is needed for the recycling of carbon dioxide from the electrodialysis unit into the electrolyzer.

In some embodiments, the electrodialysis unit is integrated into the electrolyzer. What is meant here by “integrated” is that the electrodialysis unit and the electrolyzer are bounded by the same first negatively charged end plate and the same positively charged second end plate. Between this first end plate and the second end plate are disposed both the membranes of the electrodialysis unit and the membranes and electrodes of the electrolyzer. Each electrolysis cell is bounded by a respective anode and cathode. In some embodiments, this enables a particularly compact design and the saving of material.

In some embodiments, the electrodialysis unit and the electrolyzer comprise a common voltage source. Compared to the conventional construction with an electrodialysis unit which is supplied with power separately from the electrolyzer, this saves material.

In some embodiments, the number of electrolysis cells is greater than the number of electrodialysis cells. In some embodiments, in that case, the orders of magnitude of the respective cells and also the flow rates therein are in such a relation to one another that, on the one hand, the product gas formed can be cleaned without being stored intermediately in a storage means prior to the purification in the electrodialysis unit. On the other hand, the dimensions of the electrodialysis unit are also not too large for the product gas stream formed.

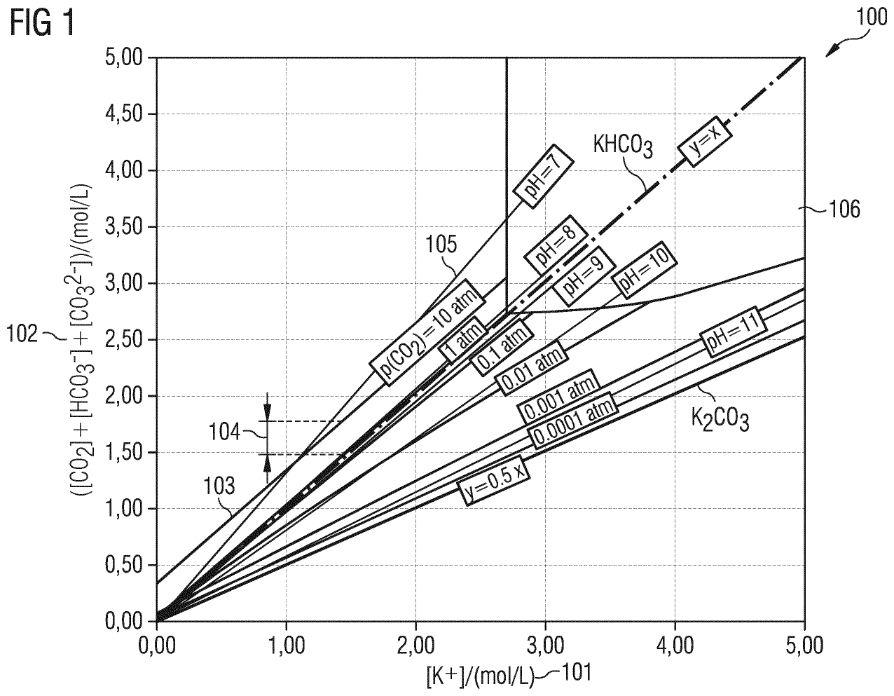

FIG. 1 shows a phase diagram of a typical electrolyte of an electrolyzer. This electrolyte especially comprises potassium hydroxide, i.e. potassium ions as well, in order to assure the conductivity of the electrolyte. The electrolyte further comprises carbon dioxide, with variation of the concentration of carbon dioxide during the electrolysis process, i.e. generally increasing in the electrolyte as catholyte.

The phase diagram shown in FIG. 1 shows the relationship between potassium ions on the x axis and the carbon dioxide concentration on the y axis. The equilibrium concentrations at a temperature of 25° C. are plotted. The carbon dioxide may be present as carbon dioxide, hydrogencarbonate, or carbonate dissolved in the potassium hydroxide solution. Plotted on the y axis is the sum total of these three components. The stated amounts correspond to mol/L. In the phase diagram, an area can be seen in the top right-hand corner, in which solid potassium hydrogencarbonate or potassium carbonate can precipitate out. This means that the solubility product for potassium hydrogencarbonate or potassium carbonate has been exceeded at this point. The rest of the area of the diagram shows a liquid phase. The isobars 103 indicate the partial pressure of carbon dioxide. Also shown in the phase diagram is the concentration at which pure solutions of potassium carbonate K2CO3 and potassium hydrogencarbonate KHCO3 would be if all carbon-containing species were carbonate and/or hydrogencarbonate. Also shown are different pH values 105.

The phase diagram illustrates that a greater amount of carbon dioxide dissolves in the electrolyte with rising potassium concentration. The absolute value depends here significantly on the partial carbon dioxide pressure 103 that exists. At very low partial carbon dioxide pressures 103, the carbon dioxide is virtually completely in the form of potassium carbonate K2CO3.

With higher partial pressures 103 of carbon dioxide, potassium hydrogencarbonate KHCO3 is also present as well as the potassium carbonate K2CO3. If the partial carbon dioxide pressure 103 is about ambient pressure, the dissolved carbon dioxide is present for the most part as potassium hydrogen-carbonate KHCO3. If the partial pressure of carbon dioxide is increased further, carbon dioxide CO2 physically dissolves in a significant amount in addition to the potassium hydrogencarbonate KHCO3.

The phase diagram is based on the assumption of thermodynamic equilibrium. In addition, ideal behavior was assumed, i.e. real effects are neglected. The phase diagram illustrates that more carbon dioxide dissolves at a higher potassium concentration and a higher partial carbon dioxide pressure 103. If the electrolyte of an electrolyzer is then circulated, the dissolved carbon dioxide accumulates until attainment of a steady state. This partial pressure is typically close to the partial pressure of a reactant gas of a carbon dioxide electrolyzer. Depending on how the electrolysis system is constructed, carbon dioxide will escape from the electrolysis system. If a “common electrolyte” is used in an electrolysis system, this is guided as anolyte and as catholyte in parallel through an anode and a cathode space of the electrolyzer and then mixed together again. If it is assumed that exclusively potassium ions are transported through a cation-permeable membrane disposed in the electrolyzer between an anode space and a cathode space, membrane, and the only ion-conducting species away from the cathode is hydrogencarbonate, the catholyte in the phase diagram migrates diagonally toward the top right, while the anolyte migrates horizontally to the left toward lower potassium concentrations. Therefore, the carbon dioxide, after attainment of the steady state, is released into the anode gas and/or, in the case of combination of anolyte and catholyte, into the environment. This also means that only one third of the carbon dioxide is used for the production of the product gas comprising carbon monoxide.

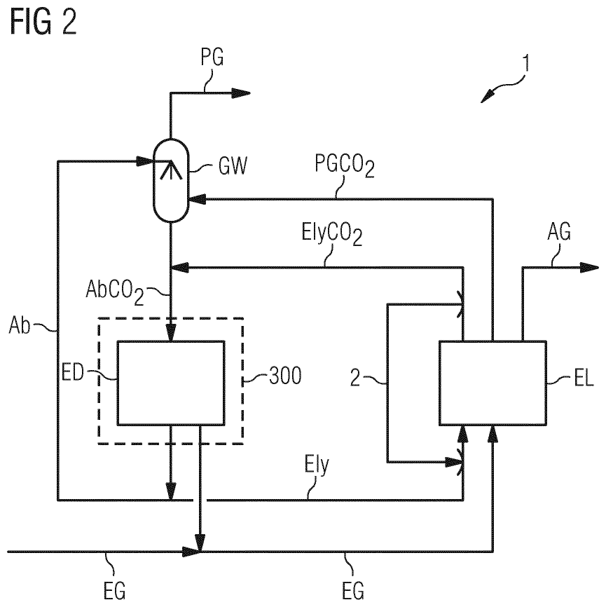

FIG. 2 illustrates how the problem of enrichment of carbon dioxide in an electrolyte of a carbon dioxide electrolyzer can be reduced or avoided with simultaneous loss of carbon dioxide into the anode gas or into the environment. FIG. 2 shows an apparatus 1 comprising a gas scrubbing apparatus GW, an electrolyzer EL and an electrodialysis unit ED. A reactant gas EG is guided into the electrolyzer EL. The reactant gas EG typically comprises carbon dioxide. In the electrolyzer EL, this carbon dioxide is reduced in a cathode space at a cathode to carbon monoxide. The electrical current and the flow rate of the reactant gas EG are chosen such that a carbon dioxide excess is present in the product gas, but the formation of unwanted hydrogen is minimized as far as possible.

This residual content of carbon dioxide can then be removed in the gas scrubbing apparatus GW. At the same time, oxygen is produced in an anode space of the electrolyzer EL. The oxygen leaves the electrolyzer EL as anode gas AG. The product gas comprising carbon monoxide and unconverted carbon dioxide PGCO2 leaves the electrolyzer EL and is guided into the gas scrubbing apparatus GW. The electrolyte Ely, or ElyCO2 when it has been enriched with carbon dioxide, can optionally be guided at least partly directly back into the electrolyzer EL. The electrolyte Ely can likewise optionally be guided at least partly into the electrodialysis unit ED. In this example, the electrolyte ElyCO2 is guided into the electrodialysis unit ED, where it is freed of carbon dioxide. The electrolyte Ely then likewise serves as absorbent Ab in the gas scrubbing apparatus GW.

In some embodiments, the electrolyte ElyCO2 is not conducted into the electrodialysis unit ED, but is guided directly back into the electrolyzer EL exclusively via the electrolyte recycling 2. What is not shown, but is an alternative, is that it is then possible that the electrolyte Ely is freed of carbon dioxide in a second electrodialysis unit and then guided back into the electrolyzer EL. It is then advantageously possible to choose an absorbent independently of the electrolyte of the electrolyzer. In this example, the absorbent used is the electrolyte Ely after it has been depleted of carbon dioxide in the electrodialysis unit ED. The electrolyte used is especially potassium hydroxide KOH. Potassium hydroxide has both a high solubility for carbon dioxide and a high conductivity.

The carbon dioxide-laden electrolyte ElyCO2 is guided into the electrodialysis unit ED together with the absorbent AbCO2 that has been laden with carbon dioxide in the gas scrubbing apparatus GW. The carbon dioxide content in the absorbent or in the electrolyte is distinctly reduced therein. The regenerated absorbent Ab is then guided at least partly back into the gas scrubbing apparatus GW. It is likewise guided at least partly as electrolyte Ely back into the electrolyzer EL. In some embodiments, the electrolyte Ely can thus be circulated without enrichment of carbon dioxide which contaminates the anode gas AG or leaves the apparatus 1 in an uncontrolled manner. In some embodiments, the carbon dioxide removed in the electrodialysis unit ED is at least partly supplied to the reactant gas EG and hence can be converted in turn to carbon monoxide in the electrolyzer EL.

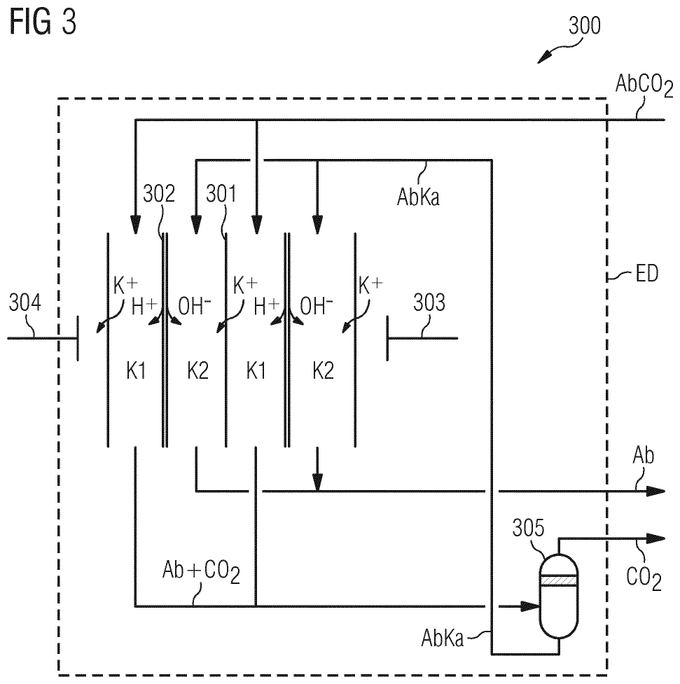

The detail view 300 illustrates the construction of the electrodialysis unit and the phase separator 305. FIG. 3 shows the electrodialysis unit ED with a phase separator 305. The carbon dioxide-laden absorbent AbCO2 which has already been mixed with the carbon dioxide-laden electrolyte ElyCO2 is first guided into the electrodialysis unit ED. In the electrodialysis unit ED there is an alternating arrangement of bipolar membranes 302 and cation-selective membranes 301. The membranes 301, 302 bound first chambers K1 and second chambers K2. The second chambers K2 are bounded toward the anode 303 by the cation-selective membrane 301. The first chambers K1 are bounded toward the anode 303 by the bipolar membrane 302.

The carbon dioxide-laden absorbent AbCO2 is guided first into the first chambers K1. In the first chambers K1, by application of potential to the cathode 304 and the anode 303, an ion flow is generated. The potassium ions can pass through the cation-permeable membrane 301. As charge balance, protons are guided out of the interlayer of the bipolar membrane 302 into the first chambers K1. As a result of the depletion of potassium ions, there is a rise in the partial pressure of carbon dioxide in the first chambers K1. This is illustrated in the phase diagram of FIG. 1. The absorbent then leaves the first chambers with the elevated partial pressure of carbon dioxide and is guided into a phase separator 305. The carbon dioxide is physically separated from the absorbent therein, especially after the establishment of the liquid-gas phase equilibrium.

The absorbent has now been depleted of carbon dioxide, but also of potassium ions. Therefore, the low-potassium absorbent AbKa is guided back into the electrodialysis unit ED, but this time into the second chambers. In the second chambers, the absorbent AbKa is enriched again with potassium. The absorbent Ab thus regenerated has a high conductivity by virtue of the potassium concentration and can then be recycled partly into the electrolyzer EL or fed as absorbent to the gas scrubbing apparatus GW. In some embodiments, potassium hydroxide is again present in the regenerated absorbent Ab.

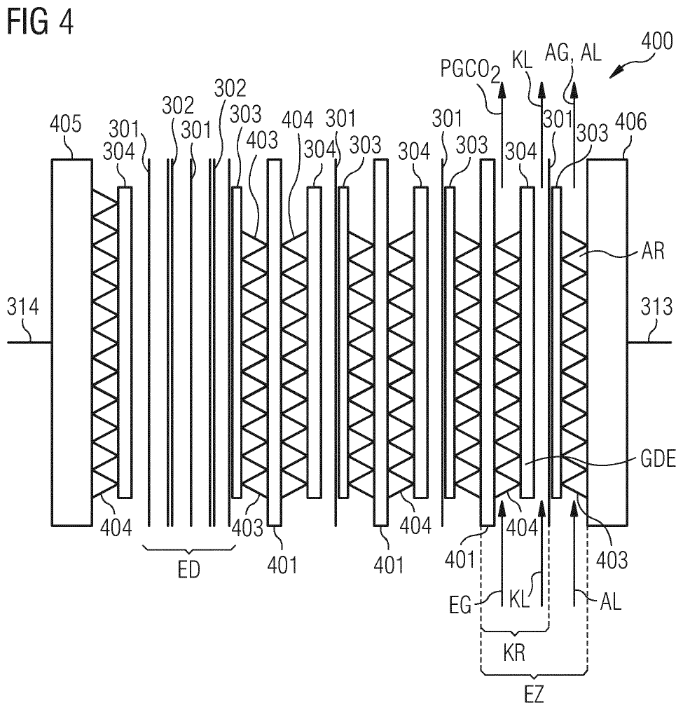

FIG. 4 shows a construction in which the electrodialysis unit ED is integrated into the electrolyzer EL. This exploits the fact that electrolysis typically takes place at the electrodes of electrodialysis systems and hydrogen and oxygen are typically produced. This results in specific electrode purges that make the construction of the electrodialysis unit ED complicated. In order to exploit this side effect, the electrodialysis unit ED can be integrated into the electrolyzer EL. What is meant here by “integrated” is that the electrodialysis unit ED and the electroanalysis cells EZ comprise a common positively charged end plate 313 and a negatively charged end plate 314.

Between the individual cells are in each case disposed contact-connection of the anode 403 and contact-connection of the cathode 404. An electrolysis cell EZ typically comprises an anode 303 mounted directly onto a cation-selective membrane 301. The anode space AR is bounded on one side by the anode 303 and on the opposite side by the second end plate 406 or, depending on the position, by the bipolar plate 401. The electrolysis cell EZ further comprises a cathode space KR which is divided by a gas diffusion electrode GDE which is used as cathode 304. In FIG. 4, the reactant gas, i.e. carbon dioxide in particular, flows along to the left of the GDE, where it is reduced to carbon monoxide. The liquid catholyte KL, i.e. a proportion of the electrolyte Ely, flows along to the right of the GDE and comes into contact with the reactant gas EG within the GDE. A liquid anolyte AL, especially a further proportion of electrolyte Ely, is guided into the anode space and enriched with anode gas, especially oxygen O2. The construction of the electrolysis cell EZ may also be analogous in the case of the non-integrated variant of the working examples in FIGS. 2 to 3.

In FIG. 4, all media inlets into the electrolysis cell EZ are shown at the bottom and all outlets from the electrolysis cell EZ at the top. This form of illustration serves for better clarity. The flow directions may likewise be reversed without leaving the scope of the teachings herein. Typically, this integrated apparatus comprises more electrolysis cells EZ than electrodialysis units ED.

What is claimed is:

1. A method for electrochemical utilization of carbon dioxide, the method comprising:
reducing carbon dioxide to a product gas in an electrolysis cell of an electrolyzer;
guiding delivering the product gas comprising carbon dioxide into a gas scrubbing apparatus;
scrubbing the product gas to remove carbon dioxide using an absorbent in the gas scrubbing apparatus;
regenerating the absorbent in an electrodialysis cell of an electrodialysis unit;
at least partly recycling the regenerated absorbent into the gas scrubbing apparatus; and
at least partly recycling the carbon dioxide released during the regenerating as reactant gas into the electrolyzer.

2. The process as claimed in claim 1, further comprising:
accumulating carbon dioxide in a salt-containing liquid electrolyte in the electrolysis cell; and delivering the carbon dioxide-enriched salt-containing liquid electrolyte into the electrodialysis cell; and
reducing the carbon dioxide content in the salt-containing liquid electrolyte using electrodialysis in the electrodialysis cell.

3. The process as claimed in claim 2, wherein the absorbent used in the gas scrubbing apparatus comprises the salt-containing liquid electrolyte with the reduced carbon dioxide content.

4. The process as claimed in claim 1, wherein the electrodialysis cell comprises:
an anode;
a cathode; and
a multitude of bipolar membranes and a multitude of cation-selective membranes in an alternating arrangement between the anode and the cathode; wherein the membranes form first chambers and second chambers;
the first chambers are bounded toward the anode by the bipolar membrane;
the second chambers are bounded toward the anode by the cation-selective membrane; and
the salt-containing electrolyte and/or the absorbent is delivered into the first chambers.

5. The process as claimed in claim 4, further comprising delivering the salt-containing electrolyte first into the first chambers of the electrodialysis cell, and then into the second chambers of the electrodialysis cell.

6. The process as claimed in claim 1, wherein the electrodialysis cell comprises:
an anode;
a cathode; and
a multitude of bipolar membranes and a multitude of anion-selective membranes in an alternating arrangement between the anode and the cathode;
wherein the membranes form first chambers and second chambers;
the first chambers are bounded toward the anode by the bipolar membrane;
the second chambers are bounded toward the anode by the anion-selective membrane; and
the salt-containing electrolyte and/or the absorbent is delivered into the second chambers.

7. The process as claimed in claim 1, wherein the salt-containing electrolyte is comprises a potassium salt.

8. The process as claimed in claim 1, further comprising operating the electrolyzer with a small carbon dioxide excess.

9. The process as claimed in claim 1, further comprising operating the electrodialysis unit at a higher operating pressure than the electrolyzer.

10. The process as claimed in claim 1, wherein the product gas comprises at least one gas selected from the group consisting of: carbon monoxide and ethene.

11. An apparatus for electrochemical utilization of carbon dioxide, the apparatus comprising
an electrolyzer having an electrolysis cell for reduction of carbon dioxide to a product gas;
a gas scrubbing apparatus to absorb unconverted carbon dioxide from the product gas at least partly into an absorbent; and
an electrodialysis unit having an electrodialysis cell suitable for regenerating the absorbent enriched with carbon dioxide during the absorption.

12. The apparatus as claimed in claim 11, wherein the electrodialysis cell comprises a first multitude of bipolar membranes and a second multitude of cation-selective membranes or anion-selective membranes, wherein the first multitude of membranes are in an alternating arrangement with the second multitude of membranes between an anode and a cathode.

13. The apparatus as claimed in claim 10, wherein the electrodialysis unit is integrated into the electrolyzer.

14. The apparatus as claimed in claim 13, wherein the electrodialysis unit and the electrolyzer share a common voltage source.

15. The apparatus as claimed in claim 13, wherein the number of electrolysis cells is greater than the number of electrodialysis cells.
